(19) United States
(12) Patent Application Publication
(10) Pub. No.: US 2005/0086232 A1
(43) Pub. Date: Apr. 21, 2005

(54) Virtual protection method and device for fiber path

(76) Inventor: Jixiong Dong, Guangdong P.R. (CN)

Correspondence Address: HARNESS, DICKEY & PIERCE, P.L.C., P.O. BOX 828, BLOOMFIELD HILLS, MI, 48303, US

(21) Appl. No.: 10/500,021

(22) PCT Filed: Jun. 14, 2002
(86) PCT No.: PCT/CN02/00420

(51) Int. Cl. G06F 17/00

(52) U.S. Cl. 707/100

(57) ABSTRACT

The invention discloses a virtual protection method for a fiber path. In the method, an optical port is physically divided into multiple minimum protection units. Based on the minimum protection units, a system is divided into more than one logic-system. In a logic-system, each node can work in one of four working modes: normal working mode, passing working mode, bridging working mode and switching working mode. When it is necessary to provide protection, a node is switched from normal working mode to the other three working modes through multiplex section protection, or sub-network connection protection, or channel protection etc. The invention also discloses a virtual protection device for a fiber path. With the method and the device according to the invention, not only disadvantages of the prior protection mode can be overcome, but also transmission networking can be more flexible, and this protection mode can satisfy the increasing requirements of users.

### FIELD OF TECHNOLOGY

The present invention relates to a virtual protection method and device for a fiber path, and provides an extended protection method based on various present protection methods of a SDH (Synchronous Digital Hierarchy) fiber network, such as protocol protection, channel protection etc.

### BACKGROUND OF THE INVENTION

At present, due to the increasing requirements to network bandwidth and the advantages of SDH transmission, size of a fiber network is developing rapidly and continuously. Consequently, self-healed protection of fiber network is getting more and more important. According to ITU-T proposal, main protection methods of SDH fiber transmission network are channel protection, multiplex section protection and sub-network connection protection etc. Among them, the multiplex section protection is the most popular protection mode for present transmission network, including 1+1 liner multiplex section protection, 1:N liner multiplex section protection and 2/4 fiber unidirectional/bi-directional multiplex section shared protection.

The basic principle of multiplex section protection is transferring switching information through K1/K2 bytes in SDH frame to implement protocol switching function. Nevertheless, as K1/K2 bytes are located at multiplex section in SDH frame, one fiber line or one optical port can only transfer one set of K1/K2 bytes. This means one fiber can only belong to one multiplex section system, namely, general multiplex section is based on optical port. There is a disadvantage of the protection mode that it cannot flexibly implement appreciate protection based on different services and thus causes waste of VC (virtual container) 4 resources on an optical port. The reason of so many SDH protection modes is that it is necessary to employ different protection modes for different application situation. For example, for application that requires shorter switching time, for example switching time within 20 ms, multiplex section protection may not satisfy the requirement, so channel protection needs to be used. In addition, multiplex section switching has an inherent disadvantage of its protocol byte, i.e. there are only four bits to represent node number, and a ring can only support at most 16 nodes (excluding REG nodes, i.e. regenerator nodes). When there are more than 16 nodes in a ring, only other protection modes can be used. In addition, for the network topology shown in FIG. 1 in which nodes A, B, C and D compose ring 101 and nodes A, B, D and E compose ring 102, when ring 101 employs multiplex section protection or channel protection, services between nodes B and E or between nodes D and E cannot be protected. Similarly, when ring 102 employs multiplex section protection or channel protection, services between nodes B and C or between nodes D and C cannot be protected.

In practice, as SDH network is getting more and more complicated, the phenomenon said above is very popular.

### SUMMARY OF THE INVENTION

An object of the invention is to provide a virtual protection method and device for a fiber path to overcome the above-mentioned shortcomings. It can not only provide full protection and flexible networking, but also provide a protection mode which can completely satisfy the requirements of users.

The virtual protection method according to the invention comprises the following steps:
a. physically dividing the optical port into multiple minimum protection units;
b. dividing the minimum protection units of more than one protection channel in each optical port into different logic-systems to form more than one logic-system;
c. each node in each logic-system working in one of the four working modes: normal working mode, passing working mode, bridging working mode and switching working mode; and
d. when the protection is needed, switching normal working mode of each node to the other three working modes.

The switching can be a multiplex section protection switching, or a sub-network connection protection switching, or a channel protection switching, or other protection switching which can accomplish the same functions.

When multiplex section protection switching happens, the step d further comprises the steps of:
d1. creating logic-systems for protection switching;
d2. obtaining four sets of pages: working pages, switching pages, bridging pages and passing pages by analyzing current configuration; and
d3. after determining whether a node is a passing node, a bridging node or a switching node, sending down a passing page under the passing node, sending down a bridging page under the bridging node and sending down a switching page under the switching node.

Here, step d3 can further comprise: if the current node sends down a passing page, directly passing input protection bus of the node to output protection bus of the node; if the node sends down a bridging page, replacing output working bus of the node with input protection bus of the node; if the node sends down a switching page, replacing output protection bus of the node with input working bus of the node.

In the above-mentioned method, the minimum protection unit is a VC4 or a VC3; the step b is mapping one or more than one of multiple VC4s or VC3s into different logic-systems to form more than one logic-system.

In the above-mentioned method, when implementing protection switching in a certain logic-system, only services of a logic-system satisfying the current logic-system protection switching trigger condition participate in the protection switching.

The method further comprises: adjusting and crossing services which are sent to the same minimum protection unit from different minimum protection units to the same minimum protection unit by a time-division cross-connect unit in the transmission system.

A virtual protection device for a fiber path according to the invention at least comprises:
a paging analyzer for analyzing configuration of a logic-system, creating corresponding working pages and storing the working pages in the switching controller said below;
a switching controller for sending down corresponding working pages to the cross-connection panel said below according to switching state; and
a cross-connection panel for performing bus connection appropriately according to the sent down working page.

The working pages can be normal working pages, or passing pages, or bridging pages, or switching pages.

The bus connection is the connection of input and output working buses of the current node, or that of input and output protection buses of the current node, or that of input protection bus and output working bus of the current node, or that of input working bus and output protection bus of the current node.

With the scheme above, as logic-systems are separated based on minimum protection unit, which can be VC4, VC3 etc., and an optical port can have multiple minimum protection units, an optical port can be divided into multiple logic-systems. Consequently, different protection modes can be selected flexibly for different services, and different logic-systems (different services, different networks) can use different switching conditions. In this way, transmission networking is more flexible and protection mode is more suitable for requirements of users. As the same system can be divided into multiple logic-systems which can employ different protection modes, the shortcoming that a system must be either this protection mode or that protection mode is overcome. In this way, more nodes can be included in the protection system. For example, the node E in FIG. 1 which cannot be protected by prior mode can be protected with the invention. It can be seen that the protection according to the invention is more flexible, comprehensive and satisfactory.

### BRIEF DESCRIPTION OF THE DRAWINGS

FIG. 1 is a diagram shows that two rings cannot be protected simultaneously.

FIG. 2 is a diagram shows that different service uses different protection mode.

FIG. 3 is a diagram for bus-cross method of an embodiment of the invention.

FIG. 4 is a diagram implementing unidirectional multiplex section switching of an embodiment of the invention.

FIG. 5 is a diagram for multiplex section switching algorithm of the invention.

FIG. 6 is a present networking diagram.

FIG. 7 is a division diagram of logic-systems for virtual path protection.

FIG. 8 is a structure diagram for virtual protection device of a fiber path of the invention.

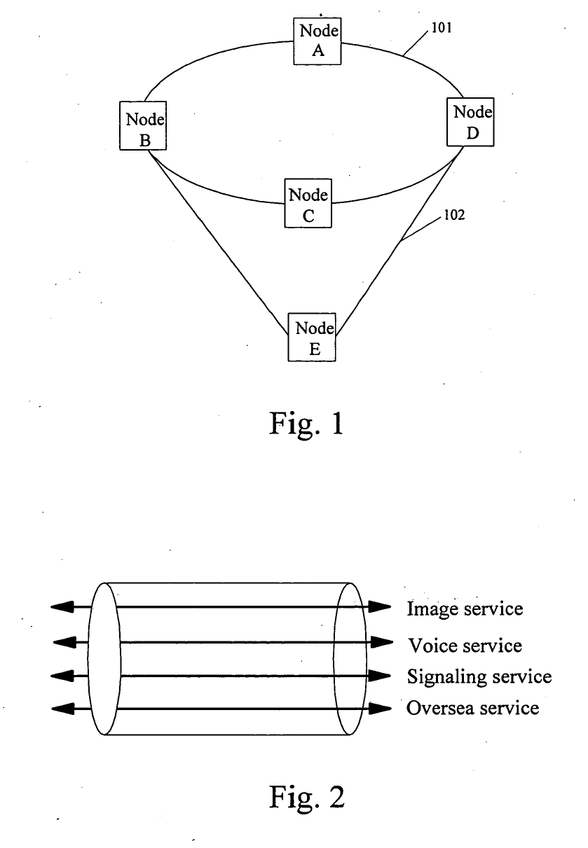

### DETAILED DESCRIPTION OF THE INVENTION

The invention will be described in more detail hereinafter with reference to the accompanying drawing.

FIG. 2 shows that the invention can implement protection of multiple services such as image service, voice service, signaling service and oversea service etc. Different services can employ different protection modes. The core ideas of the technical scheme according to the invention are shown as below.

The first idea is the concept of minimum protection unit. This is based on that an optical port can be physically divided into multiple VC4s, and a minimum protection unit is a VC4. For example, an optical port of 622 Mbit/s can be regarded as four independent VC4s because its transmission payload is four VC4s.

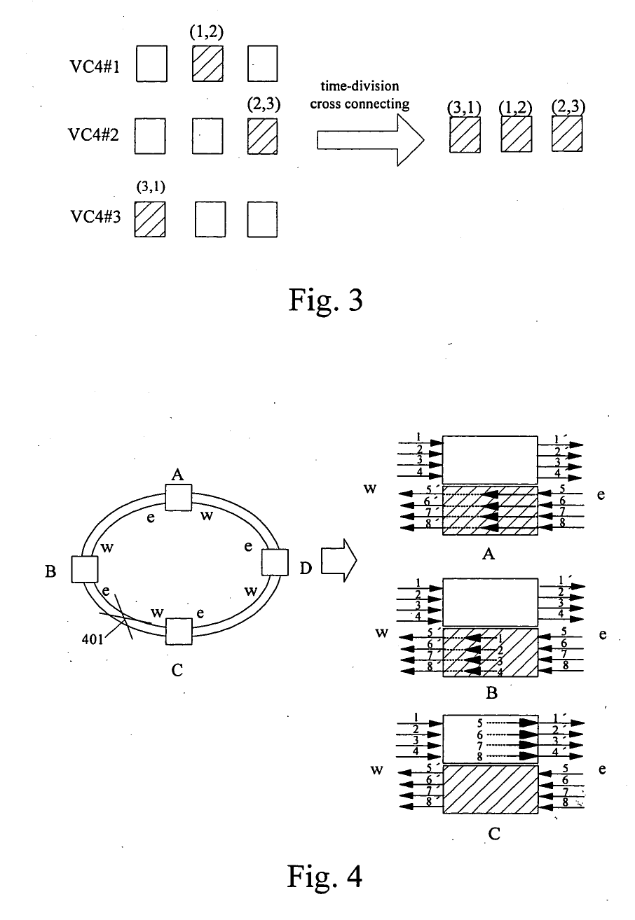

The second idea is the concept of bus. A SDH transmission system can be roughly divided into branch units, line units and cross-connect units. The logic-system division of the invention is division for line units and branch units. A switching page said below is generated by this division and different divisions generate different switching pages. Switching execution is mainly performed by the cross-connect units. For an add/drop multiplex equipment, there are many services which can be added or dropped, for example, the services of 2 Mbit/s, 34 Mbit/s and 155 Mbit/s etc.; and capacity of a line can be 155 Mbit/s, 622 Mbit/s and 2.5 Gbit/s etc. It is impossible to select different cross-connect units according to different line capacities or different adding and dropping services. When a service with low priority is added to a line, it will be multiplexed to a VC4; a time-division cross-connect unit can be used for crossing, which uniquely adjusts and crosses services coming from different VC4s to the expected VC4. Here, a VC4 can be considered as the basic speed rate of a bus unit. FIG. 3 shows meaning of the bus crossing. In the left-hand side of the arrow of FIG. 3, there are three different VC4s: VC4#1, VC4#2 and VC4#3; and the shaded blocks represent the second unit of the first VC4 (1,2), the third unit of the second VC4 (2,3) and the first unit of the third VC4 (3,1), respectively. The right-hand side of the arrow shows that after bus time-division cross connecting, a SDH system multiplexes services coming from three different VC4s to one VC4 which sequentially transfers services loaded on (3,1), (1,2) and (2,3).

The third idea is the concept of logic-system. As a node can belong to different basic network topology and each network may have different protection mode, a physical media with the same basic topology, the same level and the same protection mode can be seen as a whole, called logic-system. Characteristics of a logic-system are as follow: level, such as 155M, 622M, 2500M etc.; network element type, such as add/drop multiplexer (ADM), terminal (TM) and regenerator (REG); service direction, such as unidirectional or bi-directional; protection mode, such as channel protection, multiplex section protection, 1+1 protection, 1:N protection, sub-network connection protection etc.; fiber number, such as 2 fibers, 4 fibers; and basic network topology type, such as ring, link, etc. ADM logic-system includes east direction line, west direction line and selectable branches. TM logic-system includes east direction/west direction line and selectable branches. With these characteristics, working page and protection page are generated by analyzing add/drop service or passing through service. The concept of logic-system simplifies service configuration and provides possibility for implementing protection flexibly.

When protection switching of a logic-system happens, if other logic-systems do not satisfy the trigger condition of the logic-system protection switching, then only services on the logic-system take part in the protection switching procedure, i.e. there is logic independence.

The fourth idea is the concept of bus replacing. Multiplex section switching can be performed by the idea: one end node of a path changes to bridge mode, the other end node changes to switching mode and middle node changes to passing through mode, as shown in FIG. 4 which is a diagram illustrating unidirectional multiplex section switching of an embodiment. In FIG. 4, left part of the arrow is the network topology, which includes two fiber rings, one working channel and one protection channel, and four nodes A, B, C and D on the ring. In FIG. 4, right part of the arrow shows working states of working-channel and protection channel of three types of node: the passing node, the bridging node and the switching node; among them blank block represents working channel and shaded block represents protection channel. When fiber 401 between nodes B and C has trouble, working channel and protection channel between nodes B and C cannot work any more. The transmission services between nodes B and C or the transmission services passing through nodes B and C will transfer to the destination node through protection channels between BA, AD and DC. At this moment, node B will be bridged, node C will be switched and nodes A and D will be passed, i.e., node B is a bridging node, node C is a switching node and nodes A, D are passing nodes. In this embodiment, suppose 1˜4 in every node are working channel input buses, 1′˜4′ are working channel output buses, 5˜8 are protection channel input buses and 5′˜8′ are protection channel output buses, it can be seen from FIG. 4, for a passing node (such as nodes A and D), signals inputted to protection channel input buses (5, 6, 7, 8) are cross-connected to protection channel output buses (5′, 6′, 7′, 8′); for a bridging node (such as node B), signals outputted originally from working channel output buses (1′, 2′, 3′, 4′) are transferred to protection channel output buses (5′, 6′, 7′, 8′); for a switching node (such as node C), signals inputted originally to working channel input buses (1, 2, 3, 4) are changed to protection channel input buses (5, 6, 7, 8).

It is possible for every node to deal with all switching situations, so every node needs to prepare four pages: normal page, passing page, bridging page and switching page. The normal page comes from analyzing logic-systems, and other pages are based on normal page with bus replacement. In the invention, “replacement” and “switching” are two different concepts; replacement is a number meaning, for example, input bus 1 is replaced by input bus 9; but switching is about network element which is an action of logic-system, for example, we say logic-system has a multiplex section switching, but we cannot say logic-system has a multiplex section replacement; switching is a changing from working part to protection part.

According to the concepts mentioned above, the virtual protection method for a fiber path according to the invention comprises the following steps.
a) An optical port is physically divided into multiple minimum protection units.
b) According to service requirement, the minimum protection units of multiple protection channels of each optical port are divided into different logic-systems, so there are more than one logic-systems and an optical port is divided into multiple different logic-systems.
c) In each logic-system, each node can work in one of the four working modes: normal working mode, passing working mode, bridge working mode and switching working mode.
d) When protection is needed, normal working mode is switched to other three working modes through multiplex section switching.

The fifth idea is the concept of protection independence. Different protection characteristics have different protection conditions. Channel protection is based on channel tributary-unit alarm-indicator-signal (TU-AIS) etc. Multiple section protection is based on multiplex-section alarm-indicator-signal (MS-AIS) etc. Different protections logically belong to different network topologies and, in general, take different physical paths, so protection will not happen at the same time. Therefore, it is required that a logic-system protection does not affect other logic-system working modes.

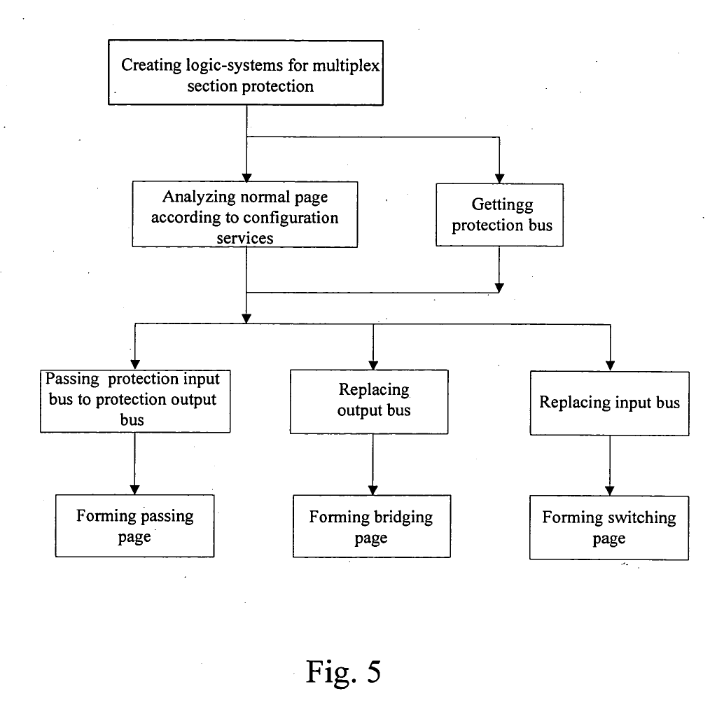

FIG. 5 shows a simple flowchart of implementing multiplex section switching algorithm. First, a logic-system for multiplex section protection is created. Then, according to the configuration, four working pages: normal working page, switching page, bridging page and passing page will have been analyzed. A normal working page is from input working bus to output working bus. A switching page is from output protection bus to input working bus. A bridging page is from output working bus to input protection bus. A passing page is from input protection bus to output protection bus. The type of the node is analyzed by a protection switching controller. If the node is a bridging node, then a bridging page is sent down and the output working bus is replaced by the input protection bus. If the node is a switching node, then a switching page is sent down and the output protection bus is replaced by the input working bus. If the node is a passing node, then a passing page is sent down, and the input protection bus is directly passed to the output protection bus. As shown in FIG. 4, when there is a fiber trouble between nodes B and C and multiplex section switching is needed, the system needs to tell what changes should happen for nodes A˜D, respectively, by analyzing current normal working pages of every node and the trouble position. After analyzing, it is defined that nodes A and D are a passing node, node B is a bridging node and node C is a switching node; then nodes A and D send down a passing page, node B sends down a bridging page and node C sends down a switching page. It can be seen from the switching algorithm that bus switching is different from convention switching mode (there is all VC4s on a port taking art the switching) with that VC4s belong to the logic-system take part the switching. Therefore, number of VC4s taking part a switching can be configured according to requirement and other VC4s can be used for other protections.

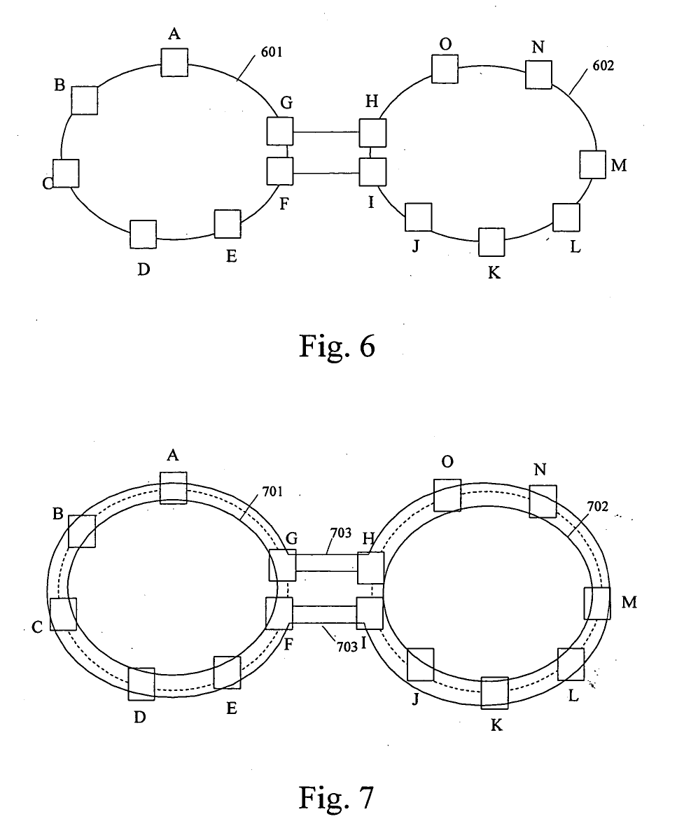

FIG. 6 is a diagram of a networking topology used in somewhere in the prior art. In term of counter-clockwise direction, network elements A, B, C, D, E, F and G compose the ring 601; network elements H, I, J, K, L, M, N and O compose the ring 602; and the two rings are connected by G, H and F. I. Services in the ring 601 and the ring 602 can be protected by means of multiplex section protection mode or other protection modes, but services between rings can not be protected.

As for the fiber rings shown in FIG. 7, although they have the same networking topology as that in FIG. 6, logic-system division of the invention is used; so any part of the fiber network can be protected. In FIG. 7, in term of the counter-clockwise direction, network elements A, B, C, D, E, F and G compose the virtual-ring 701, network elements H, I, J, K, L, M, N and O compose the virtual-ring 702, and network elements A, B, C, D, E, F, I, J, K, L, M, N, O, H and G compose the big virtual-ring 703. In virtual-rings 701 and 702, multiplex section protection can be used to protect services in the rings; and channel protection can be used for ring 703 to protect services between rings. In this design, each node is configured to two logic-systems; according to service requirement, all VC4s of each fiber can be mapped to a multiplex section logic-system or part of each fiber VC4s can be mapped to a multiplex section logic-system. For logic-system which composes the virtual-ring 703, as the logic-system spans more nodes and channel protection occupies more resources, so, in general, one or several VC4s of all optical port are mapped to the logic-system according to the number of services and the level of optical ports.

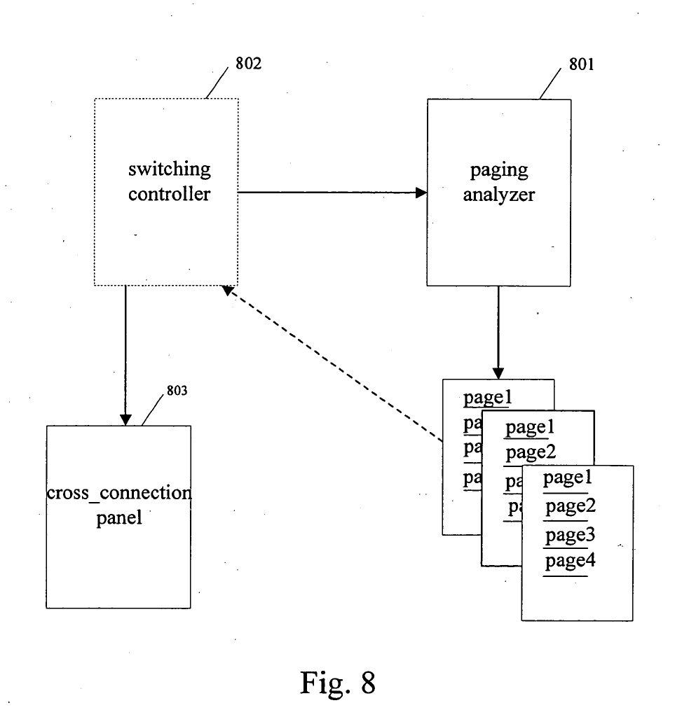

FIG. 8 shows structure of virtual protection device which implements the above-mentioned virtual protection method according to the invention. The virtual protection device of fiber path at least includes three parts: paging analyzer 801, switching controller 802 and cross-connection panel 803. Each node sends appropriate working pages according to the current switching state of itself, and performs appropriate bus connection. The page analyzer 801 is used for analyzing configuration of a logic-system, creating four working pages: normal working page, passing page, bridging page and switching page, and storing them to the switching controller 802. As each node of all nodes has many logic-systems, there are many sets of pages and every page is related to a logic-system. The switching controller 802 is used for sending down a working page to the cross-connection panel 803 according to switching state. The cross-connection panel 803 performs connection of corresponding buses. So switching action is performed.

The above description is merely the preferred embodiment of the invention, and is not to be construed as limiting protection scopes of the present invention.

1. A virtual protection method for a fiber path, comprising:
a. physically dividing the optical port into multiple minimum protection units;
b. dividing the minimum protection units of more than one protection channel in each optical port into different logic-systems to form more than one logic-system;
c. each node in each logic-system working in one of the four working modes: normal working mode, passing working mode, bridging working mode and switching working mode; and
d. when the protection is needed, switching normal working mode of each node to the other three working modes.

2. The method according to claim 1, wherein the switching is a multiplex section protection switching, or a sub-network connection protection switching, or a channel protection switching.

3. The method according to claim 2, wherein the multiplex section protection switching comprises the steps of:
d1. creating logic-systems for protection switching;
d2. obtaining four sets of pages: working pages, switching pages, bridging pages and passing pages by analyzing current configuration; and
d3. after determining whether a node is a passing node, a bridging node or a switching node, sending down a passing page to the passing node, sending down a bridging page to the bridging node and sending down a switching page to the switching node.

4. The method according to claim 3, step d3 further comprising: if the current node sends down a passing page, directly passing through input protection bus of the node to output protection bus of the node; if the node sends down a bridging page, replacing output working bus of the node with input protection bus of the node; if the node sends down a switching page, replacing output protection bus of the node with input working bus of the node.

5. The method according to claim 1, wherein the minimum protection unit is a VC4 or a VC3; the step b is mapping one or more than one of multiple VC4s or VC3s into different logic-systems to form more than one logic-system.

6. The method according to claim 1, wherein when implementing protection switching in a certain logic-system, only services of a logic-system satisfying the current logic-system protection switching trigger condition participate in the protection switching.

7. The method according to claim 1, further comprising:
adjusting and crossing services which are sent to the same minimum protection unit from different minimum protection units to the same minimum protection unit by a time-division cross-connect unit in the transmission system.

8. A virtual protection device for a fiber path, at least comprising:
a paging analyzer for analyzing configuration of a logic-system, creating corresponding working pages and storing the working pages in the switching controller said below;
a switching controller for sending down corresponding working pages to the cross-connection panel said below according to switching state; and
a cross-connection panel for performing bus connection appropriately according to the sent down working page.

9. The device according to claim 8, wherein the working pages are normal working pages, or passing pages, or bridging pages, or switching pages.

10. The device according to claim 8, wherein the bus connection is the connection of input and output working buses of the current node, or that of input and output protection buses of the current node, or that of input protection bus and output working bus of the current node, or that of input working bus and output protection bus of the current node.

11. The device according to claim 9, wherein the bus connection is the connection of input and output working buses of the current node, or that of input and output protection buses of the current node, or that of input protection bus and output working bus of the current node, or that of input working bus and output protection bus of the current node.
